(19) United States
(12) Patent Application Publication
(10) Pub. No.: US 2019/0259059 A1
(43) Pub. Date: Aug. 22, 2019

(54) SYSTEM AND METHOD FOR PREDICTING ANALYTICS

(71) Applicant: HCL Technologies Limited, Noida (IN)

(72) Inventor: Konesh CHOPRA, Pune (IN)

(21) Appl. No.: 16/278,749

(22) Filed: Feb. 19, 2019

(30) Foreign Application Priority Data
Feb. 21, 2018 (IN) 201811006660

(51) Int. Cl. G06Q 30/02; G06Q 30/00; G06F 16/9035

(52) U.S. Cl. CPC G06Q 30/0254; G06F 16/9035; G06Q 30/016; G06Q 30/0255

(57) ABSTRACT

The present disclosure relates to system(s) and method(s) for predicting analytics associated with one or more customers of an organization, the method comprises obtaining data from one or more source systems and identifying a plurality of parameters corresponding to a customer of the organization based on filtering of the data. The method further comprises generating a master copy associated with the customer based on standardization of the plurality of parameters and computing one or more of a time to accomplish a journey path and a customer acquisition rate based on principal component analysis, a customer lifetime value based on survival model methodology and a next best offer based on association rules analysis, and apriori methodology and predicting a customer with a need for a replacement or upgrade of a product associated with the organization, and a customer with an opportunity to cross-sell or up sell based on the computation.

### CROSS-REFERENCE TO RELATED APPLICATIONS AND PRIORITY

The present application claims priority from Indian Patent Application No. 201811006660 filed on 21 Feb. 2018 the entirety of which is hereby incorporated by reference

### TECHNICAL FIELD

The present disclosure in general relates to the field of analytics. More particularly, the present subject matter relates to a system and a method for predicting analytics associated with one or more customers of an organization.

### BACKGROUND

Now a day, organizations business complexity has increased may fold. Typically, this increased complexity may be attributed to increased choices to the customers, and digital devices. This in turn has led to boost in the awareness of customers while reducing their attention span. As a result, the pressure on organizations to deliver an excellent customer experience and capture customer's interest at early stage of product discovery is immense. This entails delivering personalized offers, customized choices and simplified buying journey. Manufacturers need to be able to make it easier for the customers to make a right buying decision while also collaborating with the customers during post-purchase phase to maximize loyalty. Further, with increasing competition and declining profitability, imperative to retain existing customers, understand and arrest the causes of customer churn has increased manifold. There is enhanced focus on deepening relationship with the customers and increasing customer lifetime value (CLV).

Conventional system and method fail support organizations in real-time. Further, the conventional system and method are incapable of analysing and predicting analytic related to customers that would enable organizations develop a better understanding about their customers.

### SUMMARY

Before the present a system and a method for predicting analytics associated with one or more customers of an organization, are described, it is to be understood that this application is not limited to the particular system, systems, and methodologies described, as there can be multiple possible embodiments, which are not expressly illustrated in the present disclosures. It is also to be understood that the terminology used in the description is for the purpose of describing the particular implementations, versions, or embodiments only, and is not intended to limit the scope of the present application. This summary is provided to introduce aspects related to a system and a method for predicting analytics associated with one or more customers of an organization. This summary is not intended to identify essential features of the claimed subject matter nor is it intended for use in determining or limiting the scope of the claimed subject matter.

In one embodiment, a method for predicting analytics associated with one or more customers of an organization is disclosed. In the embodiment, the method comprises the step of obtaining data from one or more source systems and identifying a plurality of parameters corresponding to a customer of the organization based on filtering of the data. The method further comprises the step of generating a master copy associated with the customer based on standardization of the plurality of parameters and computing, based on the plurality of parameters, one or more of a time to accomplish a journey path and a customer acquisition rate based on principal component analysis, a customer lifetime value based on a survival model methodology and a next best offer based on an association rules analysis, and an apriori methodology. Furthermore, the method comprise the step of predicting a customer with a need for a replacement or upgrade of a product associated with the organization, and a customer with an opportunity to cross-sell or up sell based on the computation.

In another embodiment, a system for predicting analytics associated with one or more customers of an organization is disclosed. The system comprises a memory and a processor coupled to the memory, further the processor may be configured to execute programmed instructions stored in the memory. In one embodiment, the system may obtain data from one or more source systems and identify a plurality of parameters corresponding to a customer of the organization based on filtering of the data. Upon identification, the system may generate a master copy associated with the customer based on standardization of the plurality of parameters. Further to generation, the system may compute, based on the plurality of parameters, one or more of a time to accomplish a journey path and a customer acquisition rate based on principal component analysis, a customer lifetime value based on a survival model methodology and a next best offer based on an association rules analysis, and an apriori methodology. Subsequent to computation, the system may predict a customer with a need for a replacement or upgrade of a product associated with the organization, and a customer with an opportunity to cross-sell or up sell based on the computation.

### BRIEF DESCRIPTION OF DRAWINGS

The foregoing detailed description of embodiments is better understood when read in conjunction with the appended drawings. For the purpose of illustrating of the present subject matter, an example of construction of the present subject matter is provided as figures; however, the present subject matter is not limited to the specific method and system disclosed in the document and the figures.

The present subject matter is described detail with reference to the accompanying figures. In the figures, the left-most digit(s) of a reference number identifies the figure in which the reference number first appears. The same numbers are used throughout the drawings to refer various features of the present subject matter.

FIG. 1 illustrates a network implementation of a system for predicting analytics associated with one or more customers of an organization, in accordance with an embodiment of the present subject matter.

FIG. 2 illustrates the system for predicting analytics associated with one or more customers of an organization, in accordance with an embodiment of the present subject matter.

FIG. 3 illustrates a method for predicting analytics associated with one or more customers of an organization, in accordance with an embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any a system and a method for predicting analytics associated with one or more customers of an organization, similar or equivalent to those described herein can be used in the practice or testing of embodiments of the present disclosure, the exemplary, a system and a method for predicting analytics associated with one or more customers of an organization are now described.

Various modifications to the embodiment will be readily apparent to those skilled in the art and the generic principles herein may be applied to other embodiments for predicting analytics associated with one or more customers of an organization. However, one of ordinary skill in the art will readily recognize that the present disclosure for predicting analytics associated with one or more customers of an organization is not intended to be limited to the embodiments described, but is to be accorded the widest scope consistent with the principles and features described herein.

In another embodiment, a system and method for predicting analytics associated with one or more customers of an organization is disclosed. In one embodiment, initially data may be obtained from one or more source systems and a plurality of parameters corresponding to a customer of the organization may be identified based on filtering of the data. Upon identification, a master copy associated with the customer may be generated based on standardization of the plurality of parameters. Further to generation, based on the plurality of parameters, one or more of a time to accomplish a journey path and a customer acquisition rate based on principal component analysis, a customer lifetime value based on a survival model methodology and a next best offer based on an association rules analysis, and an apriori methodology may be computed. Subsequent to computation, a customer with a need for a replacement or upgrade of a product associated with the organization, and a customer with an opportunity to cross-sell or up sell may be predicted based on the computation.

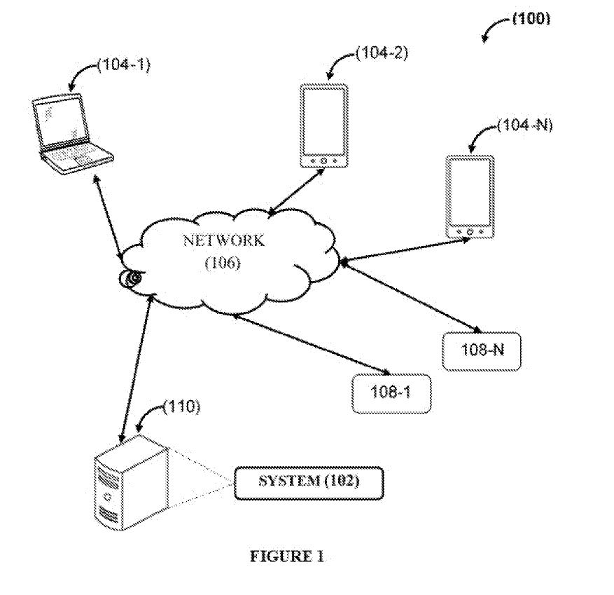

Referring now to FIG. 1, multiple embodiment of a network implementation 100 of a system 102 for predicting analytics associated with one or more customers of an organization is disclosed. Although the present subject matter is explained considering that the system 102 is implemented on a server 110, it may be understood that the system 102 may also be implemented in a variety of computing systems, such as a laptop computer, a desktop computer, a notebook, a workstation, a mainframe computer, a server, a network server, and the like. In one implementation, the system 102 may be implemented in a cloud-based environment. It will be understood that multiple users may access the system 102 through one or more user device or applications residing on the user device 104-1 . . . 104-N, herein after individually or collectively referred to as 104. Examples of the user device 104 may include, but are not limited to, a portable computer, a personal digital assistant, a handheld system, and a workstation. The device 104 may be communicatively coupled to the server 110 through a network 106.

In one implementation, the network 106 may be a wireless network, a wired network or a combination thereof. The network 106 may be implemented as one of the different types of networks, such as intranet, local area network (LAN), wide area network (WAN), the internet, and the like. The network 106 may be either a dedicated network or a shared network. The shared network represents an association of the different types of networks that use a variety of protocols, for example, Hypertext Transfer Protocol (HTTP), Hypertext Transfer Protocol Secure (HTTPS), Secure File Transfer Protocol (SFTP), Transmission Control Protocol/Internet Protocol (TCP/IP), Wireless Application Protocol (WAP), and the like, to communicate with one another. Further, the network 106 may include a variety of network systems, including routers, bridges, servers, computing systems, storage systems, and the like.

In the embodiment, a system 102 for predicting analytics associated with one or more customers of an organization. In the embodiment, the system 102 may obtain data from one or more source systems 108-1 . . . 108-N, herein after individually or collectively referred to a source system 108. In one example, the source system 108 may be a CRM system of the organization, an ERP system. Further, the system 102 may identify a plurality of parameters corresponding to a customer of the organization based on filtering of the data. Upon identification, the system 102 may generate a master copy associated with the customer based on standardization of the plurality of parameters. Further to generation, the system 102 may compute, based on the plurality of parameters, one or more of a time to accomplish a journey path and a customer acquisition rate based on principal component analysis, a customer lifetime value based on a survival model methodology and a next best offer based on an association rules analysis, and an apriori methodology. Subsequent to computation, the system 102 may predict a customer with a need for a replacement or upgrade of a product associated with the organization, and a customer with an opportunity to cross-sell or up sell based on the computation.

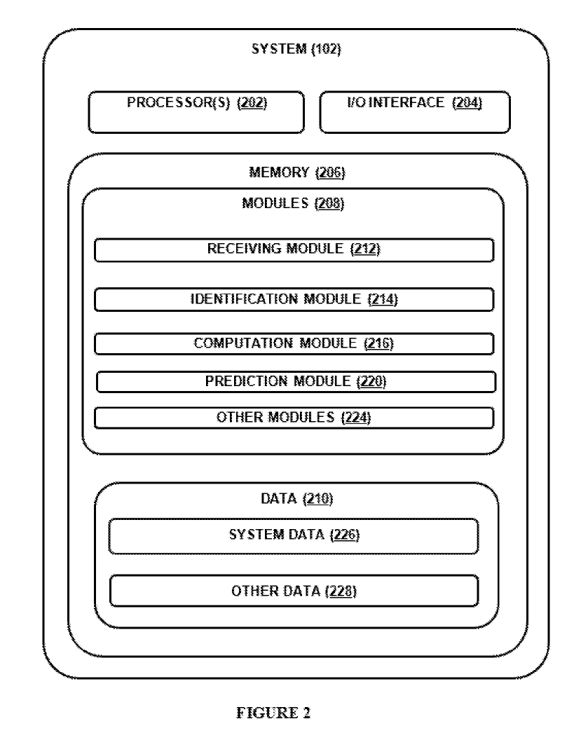

Referring now to FIG. 2, the system 102 for predicting analytics associated with one or more customers of an organization is illustrated in accordance with an embodiment of the present subject matter. The system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any systems that manipulate signals based on operational instructions. Among other capabilities, at least one processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user device 104. Further, the I/O interface 204 may enable the system 102 to communicate with other computing systems, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of systems to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 may include routines, programs, objects, components, data structures, and the like, which perform particular tasks, functions or implement particular abstract data types. In one implementation, the module 208 may include a receiving module 212, an identification module 214, a computational module 216, a prediction module 218, and other modules 224. The other modules 224 may include programs or coded instructions that supplement applications and functions of the system 102.

The data 210, amongst other things, serve as a repository for storing data processed, received, and generated by one or more of the modules 208. The data 210 may also include a system data 226, and other data 228. In one embodiment, the other data 228 may include data generated as a result of the execution of one or more modules in the other module 224.

In one implementation, a user may access the system 102 via the I/O interface 204. The user may be registered using the I/O interface 204 in order to use the system 102. In one aspect, the user may access the I/O interface 204 of the system 102 for obtaining information, providing inputs or configuring the system 102.

### Receiving Module 212

In the embodiment, the receiving module 212 may obtain data from one or more source systems (108). In example, the source system (108) comprises an enterprise CRM system a content management system and partner's network. Upon obtaining the data, the receiving module may store the data in the system data 226.

### Identification Module 214

Further, in the embodiment, the identification module 214 may identify a plurality of parameters corresponding to a customer of the organization based on filtering of the data. In one example, the plurality of parameters may be customer's profile, customer call, email and chat history, incident history; time spent on page, page visits, purchase history, product preference, customer subscription, and customer defections. Upon identifying, the identification module may store the plurality of parameters in system data 226.

Further, in the embodiment, upon storing, the identification module 214 may generate a master copy associated with the customer based on standardization of the plurality of parameters. In one example, the identification module 214 may utilize Master Data Exchange (MDX) to accelerator and to de-dupe/standardize data in order to generate a master copy of customer data. In one example, the master copy may be understood as a unified view of the customer. Further, the MDX enables metadata integration using an intuitive, user-friendly interface. In one example, the standardization process compress data staging, data standardization and data cleansing. Further, the core components include source configuration, source mapping, and rules configuration. Upon generation, the identification module 214 may store the master copy in the system data 226.

### Computational Module 216

Subsequent to generation, the computational module 216 may compute one or more of a time to accomplish a journey path and a customer acquisition rate based on principal component analysis and on the plurality of parameters. In one example, Principal component analysis (PCA) may be understood as a statistical procedure based on an orthogonal transformation to convert a set of values of possibly correlated variables into a set of values of linearly uncorrelated variables called principal components. In one other embodiment, the computation module 216 in order to compute time to accomplish journey path may generate one or more journey paths based on the channel of communication and the purposes of communication. In one example, the purposes of communication may be one or more of a purchase, a renewal, a subscription, a user registration, a returns, a service request, and an incident and the channel of communication may be one or more of a chat channel, an email channel, an IVR channel, an application channel, and a web channel. The journey path may be one or more of a purchase path using chat channel, a user registration using IVR channel, a purchase path using email channel, a purchase path using IVR channel, user registration using IVR channel and the like. In one other example, the computation module may compute an effort required by the costumer to compete a journey path based on the time.

The computation module 216 may also compute a customer lifetime value based on survival model methodology, a next best offer based on association rules analysis, and apriori methodology, a customer churn probability, a customer acquisition rate and an average customer churn probability based one or more of a principal component analysis, a logit model, and a decision tree analysis. In one example, survival analysis may be understood as a set of methods for analysing data where the outcome variable is the time until the occurrence of an event of interest, Association rule analysis may be understood as a rule-based machine learning method for discovering relations between variables in large databases and apriori methodology may be understood as a methodology for frequent item set mining and association rule learning over transactional databases. In one other example, a logit model may be understood as a regression model where the dependent variable (DV) is categorical and a decision tree analysis may be understood as a decision support tool that uses a tree-like graph or model of decisions and their possible consequences, including chance event outcomes, resource costs, and utility. The computation module 216 may furthermore compute a sentiment of a customer corresponding to each product of the organization based on the data. Upon computing the computation module 216 may store the computed data in system data 226.

### Prediction Module 218

Further upon computation, the prediction module 218 may predict one or more of a customer with a need for a replacement or upgrade of a product associated with the organization, a customer with an opportunity to cross-sell or up sell a customization of an advertisement generally and a customization of the advertisement corresponding to the customer based on the sentiment of the customer. In one example, the prediction module 218 may predict one or more steps to be taken for one or more of the journey path to reduce the effort of the customer to complete the journey path. In one other example, the prediction module 218 may predict customers generating the highest profit and strategies to retain the customers based on the customer lifetime value. In one more example, the prediction module 218 may predict which product the customer is likely to buy next and which product/s should be recommended to the ripe customers based on the next best offer.

Exemplary embodiments for predicting analytics associated with one or more customers of an organization discussed above may provide certain advantages. Though not required to practice aspects of the disclosure, these advantages may include those provided by the following features.

Some embodiments of the system and the method enable improvement in customer satisfaction and first-call-resolution rates.

Some embodiments of the system and the method provide business intelligence to implement contextual multi-channel marketing campaigns.

Some embodiments of the system and the method maximize customer lifetime value (clv).

Some embodiments of the system and the method minimize drop-outs and churn rates.

Some embodiments of the system and the method maximize cross-sell and up-sell rates.

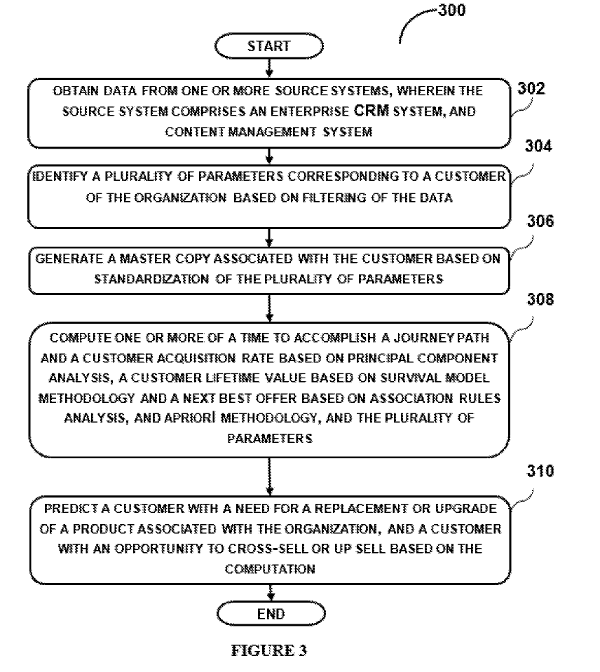

Referring now to FIG. 3, a method 300 for predicting analytics associated with one or more customers of an organization, is disclosed in accordance with an embodiment of the present subject matter. The method 300 for predicting analytics associated with one or more customers of an organization may be described in the general context of device executable instructions. Generally, device executable instructions can include routines, programs, objects, components, data structures, procedures, modules, functions, and the like, that perform particular functions or implement particular abstract data types. The method 300 for predicting analytics associated with one or more customers of an organization may also be practiced in a distributed computing environment where functions are performed by remote processing systems that are linked through a communications network. In a distributed computing environment, computer executable instructions may be located in both local and remote computer storage media, including memory storage systems.

The order in which the method 300 for predicting analytics associated with one or more customers of an organization is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method 300 can be implemented in any suitable hardware, software, firmware, or combination thereof. However, for ease of explanation, in the embodiments described below, the method 300 for predicting analytics associated with one or more customers of an organization may be considered to be implemented in the above-described system 102.

At block 302, data from one or more source systems (108) may be obtained. In one example, the source system (108) may comprise an enterprise CRM system, and a content management system. In one embodiment, the receiving module 212 may obtain data from one or more source systems (108). Further, the receiving module 212 may store the data in the system data 226.

At block 304, a plurality of parameters corresponding to a customer of the organization may be identified based on filtering of the data. In one embodiment, the identification module 214 may identify a plurality of parameters corresponding to a customer of the organization and store the plurality of parameters in system data 226.

At block 306, a master copy associated with the customer may be generated based on standardization of the plurality of parameters. In one embodiment, the identification module 214 may generate a mater copy associated with the customer and store the master copy in the system data 226.

At block 308, based on the plurality of parameters, one or more of a time to accomplish a journey path and a customer acquisition rate based on principal component analysis, a customer lifetime value based on survival model methodology and a next best offer based on association rules analysis, and apriori methodology may be computed. In one embodiment, the computation module 216 may compute a time to accomplish a journey path and a customer acquisition rate, customer lifetime value, and a next best offer. Further, the computation module 216 may store the time to accomplish a journey path, customer acquisition rate, the customer lifetime value, and the next best offer.

At block 310, a customer with a need for a replacement or upgrade of a product associated with the organization, and a customer with an opportunity to cross-sell or up sell may be predicted based on the computation. In one implementation, the prediction module 220 may predict a customer with a need for a replacement or upgrade of a product associated with the organization, and a customer with an opportunity to cross-sell or up sell may be predicted. Further, the prediction module 220 may store the prediction in the system data 226.

Although implementations for methods and systems for predicting analytics associated with one or more customers of an organization have been described in language specific to structural features and/or methods, it is to be understood that the appended claims are not necessarily limited to the specific features or methods for predicting analytics associated with one or more customers of an organization described. Rather, the specific features and methods are disclosed as examples of implementations for predicting analytics associated with one or more customers of an organization.

1. A method for predicting analytics associated with one or more customers of an organization, the method comprising:
obtaining, by a processor, data from one or more source systems (108), wherein the source system (108) comprises an enterprise CRM system, and a content management system;
identifying, by the processors, a plurality of parameters corresponding to a customer of the organization based on filtering of the data;
generating, by the processor, a master copy associated with the customer based on standardization of the plurality of parameters;
computing, by the processor, based on the plurality of parameters, one or more of a time to accomplish a journey path and a customer acquisition rate based on principal component analysis, a customer lifetime value based on survival model methodology and a next best offer based on association rules analysis, and apriori methodology; and
predicting, by the processor, a customer with a need for a replacement or upgrade of a product associated with the organization, and a customer with an opportunity to cross-sell or up sell based on the computation.

2. The method of claim 1, comprises recommending, by the processor, a customization of an advertisement based on the prediction.

3. The method of claim 1, wherein the computation of the time to accomplish journey path comprises:
generating, by the processor, one or more journey paths, wherein the journey path is one or more of a purchase path, a renewal path, a subscription path, an user registration path, a returns path, a service request path, and an incident path; and
filtering, by the processor, the data based on the channel of communication, wherein the channel of communication is one or more of a chat channel, an email channel, a IVR channel, an application channel, and a web channel.

4. The method of claim 1, further comprising computing, by the processor, a customer churn probability and an average customer churn probability based on the plurality of parameters and one or more of a principal component analysis, a logit model, a decision tree analysis.

5. The method of claim 1, further comprising
computing, by the processor, a sentiment of a customer corresponding to each product of the organization based on the data; and
predicting, by the processor, a customization of the advertisement corresponding to the customer based on the sentiment.

6. The method of claim 1, wherein the next best offer comprises a list of product in an order of customer most likely to buy based on the data parameters.

7. A system for predicting analytics associate with one or more customers of and organization, the system comprising:
a memory; and
a processor coupled to the memory, wherein the processor is configured to:
obtaining data from one or more source systems (108), wherein the source system (108) comprises an enterprise CRM system, and a content management system;
identifying a plurality of parameters corresponding to a customer of the organization based on filtering of the data;
generating a master copy associated with the customer based on standardization of the plurality of parameters;
computing, based on the plurality of parameters, one or more of a time to accomplish a journey path and a customer acquisition rate based on principal component analysis, a customer lifetime value based on a survival model methodology and a next best offer based on an association rules analysis, and an apriori methodology; and
predicting a customer with a need for a replacement or upgrade of a product associated with the organization, and a customer with an opportunity to cross-sell or up sell based on the computation.

8. The system of claim 7, further comprising recommending a customization of an advertisement based on the prediction.

9. The system of claim 7, wherein the computation of the time to accomplish journey path comprises:
generating one or more journey paths, wherein the journey path is one or more of a purchase path, a renewal path, a subscription path, an user registration path, a returns path, a service request path, and an incident path; and
filtering the data based on the channel of communication, wherein the channel of communication is one or more of a chat channel, an email channel, an IVR channel, an application channel, and a web channel.

10. The system of claim 7, further comprising computing a customer churn probability and an average customer churn probability based on the plurality of parameters and one or more of a principal component analysis, a logit model, and a decision tree analysis.

11. The system of claim 7, further comprising
computing a sentiment of a customer corresponding to each product of the organization based on the data; and
predicting a customization of the advertisement corresponding to the customer based on the sentiment.

12. The system of claim 7, wherein the next best offer comprises a list of product in an order of customer most likely to buy based on the data parameters.
